(19) United States
(12) Patent Application Publication
(10) Pub. No.: US 2018/0065146 A1
(43) Pub. Date: Mar. 8, 2018

(54) 3D GLASS CANDLE LAMP AND MANUFACTURING METHOD THEREOF

(71) Applicant: DONGGUAN ESTIN HOME PRODUCTS CO. LTD, DongGuan City (CN)

(72) Inventor: Shibo LIU, DongGuan City (CN)

(21) Appl. No.: 15/284,353

(22) Filed: Oct. 3, 2016

(30) Foreign Application Priority Data
Sep. 5, 2016 (CN) 201610800920.0

(51) Int. Cl. B05D 3/06; F21S 6/00; F21S 9/02; F21S 10/04; F21V 23/04; F21V 23/00; F21V 3/04; C25D 3/04; C25D 5/54; C25D 21/04; C25D 3/46; B05D 1/02; B05D 7/00

(52) U.S. Cl. CPC B05D 3/06; F21S 6/001; F21S 9/02; F21S 10/04; F21V 23/0435; F21V 23/003; F21Y 2115/10; C25D 3/04; C25D 5/54; C25D 21/04; C25D 3/46; B05D 1/02; B05D 7/54; F21V 3/0418

(57) ABSTRACT

The present invention relates to a production technique of a 3D glass candle lamp. Transparent glass is processed, the interior of the glass is formed by a laser method, and by conducting electroplating and color plating on the inner surface and the outer surface of the glass correspondingly, under the condition that a light source of the glass lamp is available, light is reflected by the inner electroplated layer and the outer electroplated layer, and thus clearly-layered 3D patterns are formed at the positions of laser patterns; in addition, the colors of the patterns can change along with plating colors and the color of the light source, and the scene illumination effect is additionally achieved.

### BACKGROUND OF THE INVENTION

### Technical Field

The invention relates to the field of lamps, in particular to a 3D glass candle lamp and a manufacturing method thereof.

2. Description of Related Art

Lamps are indispensable necessary articles in the life, work and entertainment of people, and lamps mainly have the two purposes of ordinary illumination and scene illumination. With the improvement of living standards, people's requirements for scene illumination have become increasingly higher, and mass merchants and suppliers are also actively developing various scene illumination tools. The stereoscopic impression of 3D patterns is accepted by people and is popular with people all the time, so that people hope that the 3D patterns and lamps can be used in combination, and the requirement of people for scene illumination can be met.

At present, a method for forming patterns in glass by conducting etching on the transparent glass is available. However, the combination of the 3D patterns formed through the method and lamp light cannot achieve a vivid 3D effect.

### BRIEF SUMMARY OF THE INVENTION

The invention aims to solve the above technical problems and provides a 3D glass candle lamp and a manufacturing method thereof.

A manufacturing method of a 3D glass candle lamp comprises the following steps that (1) transparent glass is selected and cleaned completely; (2) a chromium layer is evenly electroplated on the inner side of the glass by a vacuum electroplating method; (3) 3D patterns needing to be formed are formed on the glass by a laser method according to the design requirement; (4) protective paint is evenly sprayed on the electroplated chromium layer; (5) seven colors are electroplated on the outer side of the glass; (6) electrostatic paint is sprayed on the outer side of the glass, so that a 3D glass lamp shade is obtained; (7) an LED lamp string is installed inside the lamp shade, a candle lamp bead is installed at the top of the lamp shade and fixedly connected with power supply equipment, and the lamp shade is sealed.

In one embodiment, in step (1), a cleaning agent is used for cleaning.

In one embodiment, in step (2), the vacuum electroplating time is 8-12 min, and the oxygen flux is 280-320 sccm.

In one embodiment, in step (4), the protective paint is further coated with colored sand, and the corresponding colors of the colored sand are selected according to actual product requirements.

In one embodiment, in step (5), the seven colors are colors corresponding to the colored sand.

A 3D glass candle lamp comprises a glass lamp body; the glass lamp body comprises a lamp shade, a light source and power supply equipment, and the glass lamp body is manufactured according to the above method; the light source comprises an LED lamp string arranged inside the lamp shade and a candle lamp bead installed at the top end of the lamp shade, and the light source is electrically connected with the power supply equipment.

In one embodiment, a groove is formed in the top end of the lamp shade, and the candle lamp bead is installed in the groove.

In one embodiment, a wire hole is formed in the bottom end of the groove, and the candle lamp bead is connected with the power supply equipment through the wire hole.

In one embodiment, the glass lamp body further comprises an intelligent control system and a wireless remote control, the intelligent control system is connected with the light source, the control system comprises a single-chip microcomputer, a processor and a signal receiver, a signal transmitter corresponding to the signal receiver is arranged in the wireless remote control, and lamplight, color and on-off adjustment keys are arranged on the wireless remote control.

In one embodiment, the power supply equipment comprises one of a battery, a socket, or a charging source.

In conclusion, according to the production technique of the 3D glass candle lamp, the transparent glass is processed, the interior of the glass is formed by a laser method, and by conducting electroplating and color plating on the inner surface and the outer surface of the glass correspondingly, under the condition that a light source of the glass lamp is available, light is reflected by the inner electroplated layer and the outer electroplated layer, and thus clearly-layered 3D patterns are formed at the positions of laser patterns; in addition, the colors of the patterns can change along with the plating colors and the color of the light source, and the scene illumination effect is additionally achieved.

### BRIEF DESCRIPTION OF THE SEVERAL VIEWS OF THE DRAWINGS

FIG. 1 is a structural schematic diagram of a 3D glass candle lamp of one embodiment of the invention.

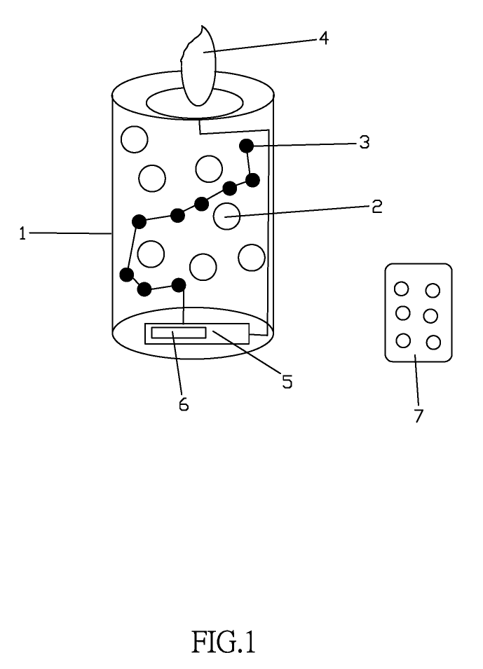

### DETAILED DESCRIPTION OF THE INVENTION

A further detailed description of the invention is given with the accompanying drawing and embodiments as follows.

A manufacturing method of a 3D glass candle lamp comprises the following steps that (1) transparent glass is selected and cleaned completely; (2) a chromium layer is evenly electroplated on the inner side of the glass by a vacuum electroplating method; (3) 3D patterns 2 needing to be formed are formed on the glass by a laser method according to the design requirement; (4) protective paint is evenly sprayed on the electroplated chromium layer; (5) seven colors are electroplated on the outer side of the glass; (6) electrostatic paint is sprayed on the outer side of the glass, so that a 3D glass lamp shade 1 is obtained; (7) an LED lamp string 3 is installed inside the lamp shade 1, a candle lamp bead 4 is installed at the top of the lamp shade 1 and fixedly connected with power supply equipment 5, and the lamp shade 1 is sealed. The LED lamp string 3 is sealed inside the 3D glass lamp so that a light source of the LED lamp string 3 can directly irradiate the interior of the glass after the 3D glass lamp is powered on, light is reflected by the electroplated layer on the outer side of the lamp shade 1 in the outward irradiation process, and thus the vivid 3D patterns 2 are formed in laser patterns 2.

In one embodiment, in step (1), a cleaning agent is used for cleaning. The cleaning agent mainly contains fatty alcohol-polyoxyethylene ether, polyoxyethylene coconut oil olein, butyl cellosolve, propylene glycol n-butyl ether and ammonia water; by the adoption of the cleaning agent, grease and dirt on the surface of the glass can be effectively removed, and the quality of a film plated on the surface of the glass can be improved.

In one embodiment, in step (2), the vacuum electroplating time is 8-12 min, and the oxygen flux is 280-320 sccm.

In one embodiment, in step (4), the protective paint is further coated with colored sand, and the corresponding colors of the colored sand are selected according to actual product requirements. The colored sand is smeared on the inner side of the glass through glue, and in the using process of the 3D glass lamp, light emitted by the light source can be reflected on the colored sand so as to be in colors corresponding to the colored sand, and the scene applicability of the 3D glass lamp is improved.

In one embodiment, in step (5), the seven colors are the colors corresponding to the colored sand. Light of the light source can only be formed in the laser patterns 2 in the glass under the action of dual reflection of the inner layer and the outer layer of the glass, the seven colors correspond to the colors of the colored sand, and thus the colors of the lamplight of the glass lamp can be adjusted and changed.

A 3D glass candle lamp comprises a glass lamp body; the glass lamp body comprises a lamp shade 1, a light source and power supply equipment 5, and the glass lamp body is manufactured according to the above method; the light source comprises an LED lamp string 3 arranged inside the lamp shade 1 and a candle lamp bead 4 installed at the top end of the lamp shade 1, and the light source is electrically connected with the power supply equipment 5. Through the candle lamp bead 4 installed at the top of the glass lamp body, when the glass candle lamp is in use, the top of the glass candle lamp is similar to a candle, and the interestingness of scene illumination is improved; meanwhile, the candle lamp bead 4 at the top is beneficial to the illumination effect.

In one embodiment, a groove is formed in the top end of the lamp shade 1, and the candle lamp bead 4 is arranged in the middle of the groove. The candle lamp bead 4 is arranged at the top end of the lamp shade 1 and located in the middle of the groove so that the 3D glass lamp can be in the shape of a candle and can be made in the form of a candle lamp, the options and using interestingness of the 3D glass lamp are enriched, and the requirement of people for scene illumination is better met. The candle lamp bead 4 can be in various shapes such as a flame shape, a diamond shape and a heart shape, so that scene illumination requirements are enriched.

In one embodiment, a wire hole is formed in the bottom end of the groove, and the candle lamp bead 4 is connected with the power supply equipment 5 through the wire hole. The candle lamp bead 4 is installed in the groove in the top end of the lamp shade 1, and the wire hole is formed in the bottom of the groove so that the candle lamp bead 4 and the power supply equipment 5 inside the lamp shade 1 can be connected conveniently.

In one embodiment, the glass lamp body further comprises an intelligent control system 6 and a wireless remote control 7; the intelligent control system 6 is connected with the light source, and the control system comprises a single-chip microcomputer, a processor and a signal receiver; a signal transmitter corresponding to the signal receiver is arranged in the wireless remote control 7, and lamplight, color and on-off adjustment keys are arranged on the wireless remote control 7. When the glass candle lamp is in use, the lamplight or color or on-off of the glass lamp body is adjusted and controlled through the adjustment keys on the wireless remote control; when the adjustment keys on the wireless remote control are pressed, the signal transmitter inside the wireless remote control transmits an adjustment signal, the signal receiver receives the signal and then transmits the signal to the single-chip microcomputer, and finally corresponding parameters of the glass lamp body are adjusted through the processor.

In one embodiment, the power supply equipment 5 comprises one of a battery, a socket or a charging source. The lamp can be in use directly through the battery or the charging source, and thus the lamp can be moved conveniently; meanwhile, the lamp can also be in use through the socket so that the trouble that the battery runs out of electricity can be avoided, and using by customers is facilitated.

The following is specific embodiments of the manufacturing technique of the 3D glass candle lamp:

### Embodiment I

(1) transparent glass is selected and cleaned completely with a cleaning agent; (2) a chromium layer is evenly electroplated on the inner side of the glass by a vacuum electroplating method, the vacuum electroplating time is 8 min, and the oxygen flux is 320 sccm; (3) round patterns 2 are formed on the glass by a laser method according to the design requirement; (4) protective paint is evenly sprayed on the electroplated chromium layer, and the protective paint is coated with red colored sand; (5) a red film is electroplated on the outer side of the glass; (6) electrostatic paint is sprayed on the outer side of the glass, so that a 3D glass lamp shade 1 is obtained; (7) an LED lamp string 3 is arranged inside the lamp shade 1, a flame-shaped candle lamp bead 4 is installed at the top of the lamp shade 1 and fixedly connected with power supply equipment 5, and the lamp shade 1 is sealed.

### Embodiment II

(1) transparent glass is selected and cleaned completely with a cleaning agent; (2) a chromium layer is evenly electroplated on the inner side of the glass by a vacuum electroplating method, the vacuum electroplating time is 12 min, and the oxygen flux is 280 sccm; (3) star-shaped patterns 2 are formed on the glass by a laser method according to the design requirement; (4) protective paint is evenly sprayed on the electroplated chromium layer, and the protective paint is coated with yellow colored sand; (5) a yellow film is electroplated on the outer side of the glass; (6) electrostatic paint is sprayed on the outer side of the glass, so that a 3D glass lamp shade 1 is obtained; (7) an LED lamp string 3 is arranged inside the lamp shade 1, a diamond-shaped candle lamp bead 4 is installed at the top of the lamp shade 1 and fixedly connected with power supply equipment 5, and the lamp shade 1 is sealed.

### Embodiment III

(1) transparent glass is selected and cleaned completely with a cleaning agent; (2) a chromium layer is evenly electroplated on the inner side of the glass by a vacuum electroplating method, the vacuum electroplating time is 10 min, and the oxygen flux is 300 sccm; (3) flower patterns 2 are formed on the glass by a laser method according to the design requirement; (4) protective paint is evenly sprayed on the electroplated chromium layer; (5) a silver film is electroplated on the outer side of the glass; (6) electrostatic paint is sprayed on the outer side of the glass, so that a 3D glass lamp shade 1 is obtained; (7) an LED lamp string 3 is arranged inside the lamp shade 1, a heart-shaped candle lamp bead 4 is installed at the top of the lamp shade 1 and fixedly connected with power supply equipment 5, and the lamp shade 1 is sealed.

The above embodiments are only preferred embodiments of the invention, and what needs to be pointed out is that for those skilled in the field, improvements and transformations can be made on the premise of not deviating from the principle of the invention, and the improvements and transformations are within the protection scope not deviating from the invention.

What is claimed is:

1. A manufacturing method of a 3D glass candle lamp, characterized by comprising the following steps that (1) transparent glass is selected and cleaned completely; (2) a chromium layer is evenly electroplated on the inner side of the glass by a vacuum electroplating method; (3) 3D patterns needing to be formed are formed on the glass by a laser method according to the design requirement; (4) protective paint is evenly sprayed on the electroplated chromium layer; (5) seven colors are electroplated on the outer side of the glass; (6) electrostatic paint is sprayed on the outer side of the glass, so that a 3D glass lamp shade is obtained; (7) an LED lamp string is installed inside the lamp shade, a candle lamp bead is installed at the top of the lamp shade and fixedly connected with power supply equipment, and the lamp shade is sealed.

2. The manufacturing method of the 3D glass candle lamp according to claim 1, characterized in that in step (1), a cleaning agent is used for cleaning.

3. The manufacturing method of the 3D glass candle lamp according to claim 1, characterized in that in step (2), the vacuum electroplating time is 8-12 min, and the oxygen flux is 280-320 sccm.

4. The manufacturing method of the 3D glass candle lamp according to claim 1, characterized in that in step (4), the protective paint is further coated with colored sand, and corresponding colors of the colored sand are selected according to actual product requirements.

5. The manufacturing method of the 3D glass candle lamp according to claim 4, characterized in that in step (5), the seven colors are colors corresponding to the colored sand.

6. A 3D glass candle lamp, comprising a glass lamp body, wherein the glass lamp body comprises a lamp shade, a light source and power supply equipment; characterized in that the glass lamp body is manufactured according to the above method, the light source comprises an LED lamp string arranged inside the lamp shade and a candle lamp bead installed at the top end of the lamp shade, and the light source is electrically connected with the power supply equipment.

7. The 3D glass candle lamp according to claim 6, characterized in that a groove is formed in the top end of the lamp shade, and the candle lamp bead is installed in the groove.

8. The 3D glass candle lamp according to claim 7, characterized in that a wire hole is formed in the bottom end of the groove, and the candle lamp bead is connected with the power supply equipment through the wire hole.

9. The 3D glass candle lamp according to claim 6, characterized in that the glass lamp body further comprises an intelligent control system and a wireless remote control, the intelligent control system is connected with the light source, the control system comprises a single-chip microcomputer, a processor and a signal receiver, a signal transmitter corresponding to the signal receiver is arranged in the wireless remote control, and lamplight, color and on-off adjustment keys are arranged on the wireless remote control.

10. The 3D glass candle lamp according to claim 6, characterized in that the power supply equipment comprises one of a battery, a socket or a charging source.
